(19) United States
(12) Patent Application Publication
(10) Pub. No.: US 2018/0159975 A1
(43) Pub. Date: Jun. 7, 2018

(54) METHOD AND DEVICE FOR REMINDING CONTACT INFORMATION

(71) Applicant: ZTE CORPORATION, Shenzhen, Guangdong (CN)

(72) Inventors: Haiqi ZHAO, Shenzhen, Guangdong (CN); Yuanyuan XU, Shenzhen, Guangdong (CN)

(21) Appl. No.: 15/577,002

(22) PCT Filed: Aug. 10, 2015
(86) PCT No.: PCT/CN2015/086534

§ 371 Date: Nov. 27, 2017

(30) Foreign Application Priority Data
May 27, 2015 (CN) 201510279698.X

(51) Int. Cl. H04M 3/42; H04M 1/725; H04L 12/58; H04W 8/18

(52) U.S. Cl. CPC H04M 3/42059; H04M 1/72552; H04W 8/20; H04W 8/183; H04L 51/32

(57) ABSTRACT

A method and device for reminding contact modes are disclosed. In some embodiments, the method includes: a calling end initiates a call and detects a call state of a call; and interaction information used for inquiring whether to send a short message to a current call number is displayed if a detected call state shows that a called end is busy.

### TECHNICAL FIELD

The present disclosure relates to, but not limited to a communication terminal technology, and particularly relates to a method and device for reminding contact information based on a communication terminal.

### BACKGROUND

It is well-known that communication terminals such as fixed-line telephones and mobile terminals are widely popularized. At present, when a communication terminal is used to make a call, call states on a called end generally include: a busy state, an unavailable state, an out of service state, a vacant number state, a call completing state and the like. At present, the call states are judged and obtained by a user on a calling end according to prompt voice in a call. By taking a case that the call state is busy on the called end as an example, at this moment, the calling end generally prompts “the called end is busy”.

Generally, when the call state of the user on the calling end for the user on the called end is call failure, after the calling end terminates the call, the user on the calling end searches other contact information of the user on the called end from the calling end, such as other call numbers, or other social accounts, e.g., Wechat accounts, and contacts the user on the called end in other searched contact information through the calling end. In the present disclosure, other call numbers of the user on the called end are known as call numbers which are called, i.e., associated call numbers of the current call number; and similarly, other social accounts of the user on the called end are known as associated social accounts of the call number which is called. Generally, the associated call numbers and the associated social accounts are stored in contact information in a phone book of the communication terminal. Namely, the associated call numbers and the associated social accounts correspond to users on the same calling end, wherein if the call states are the busy state, the unavailable state, the out of service state or the vacant number state, it represents a call failure.

It is easy to see that after call failure on the communication terminal in a relevant technology, the user on the calling end needs to search other contact information of the user on the called end, resulting in that the user on the calling end feels very troublesome and reducing user experience of the communication terminal.

### SUMMARY

The following is a brief summary of subject matter that is described in greater detail herein. This summary is not intended to limit a protection range of claims.

Embodiments of the present disclosure provide a method and device for reminding contact information, so as to solve a technical problem about how to contact a user on a called end conveniently and quickly after a call failure.

Embodiments of the present disclosure disclose a method for reminding contact information, including:

initiating, by a calling end, a call and detecting a call state; and

displaying, by the calling end, interaction information used for inquiring whether to send a short message to a current call number if a detected call state shows that a called end is busy.

The method further includes: detecting, after detecting the call state, whether the calling end has an associated call number of the current call number if the current call number is stored in a contact information set of the calling end, and the call state detected by the calling end shows that the called end is unavailable or out of service; and

displaying, if the associated call number exists, interaction information used for inquiring whether to call the detected associated call number.

A step of displaying interaction information used for inquiring whether to call a detected associated call number includes: displaying the associated call number; and

a method of displaying the associated call number includes: displaying the associated call number according to a sequence of a recently contacted associated call number, an associated call number belonging to a same home location with the current call number, and other associated call numbers.

The method further includes: detecting, by the calling end, whether the calling end has an associated social account of the current call number if detecting that no associated call number exists;

displaying the detected associated social account if the associated social account exists; and

starting, if the displayed associated social account is selected, an application program corresponding to the selected associated social account.

The method further includes: displaying, after detecting the call state, interaction information used for inquiring whether to delete the current call number if the current call number is stored in a contact information set of the calling end, and the call state detected by the calling end shows that the current call number is a vacant number.

The method further includes: setting, after displaying the interaction information used for inquiring whether to delete the current call number, a state of the current call number as a vacant number if the current call is not deleted.

The method further includes: displaying, after detecting the call state, interaction information used for inquiring whether to send a short message to the current call number if the current call number is not stored in a contact information set of the calling end, and the call state detected by the calling end shows that the current call number is unavailable.

Embodiments of the present disclosure further disclose an device for reminding contact information, including a call state detecting unit and a call failure processing unit, wherein

the call state detecting unit is configured to initiate a call and detect a call state of the call; and

the call failure processing unit is configured to display interaction information used for inquiring whether to send a short message to a current call number if a detected call state shows that a called end is busy.

The call failure processing unit is further configured to: detect whether the calling end has an associated call number of the current call number when the call state shows that the called end is unavailable or out of service and the current call number is stored in a contact information set of the calling end; and display, if the associated call number exists, interaction information used for inquiring whether to call a detected associated call number.

The call failure processing unit is configured to: detect whether the calling end has an associated call number of the current call number when the call state shows that the called end is unavailable or out of service and the current call number is stored in a contact information set of the calling end; display, if the associated call number exists, the detected associated call number according to a sequence of a recently contacted associated call number, an associated call number belonging to a same home location with the current call number, and other associated call numbers; and, display other information in the interaction information.

The call failure processing unit is further configured to: detect whether the calling end has an associated social account of the current call number when detecting that the calling end has no associated call number; display, if the associated social account exists, the detected associated social account; and start, if the displayed associated social account is selected, an application program corresponding to the selected associated social account.

The call failure processing unit is further configured to: display interaction information used for inquiring whether to delete the current call number when the call state shows that the current call number is a vacant number and the current call number is stored in a contact information set of the calling end.

The call failure processing unit is further configured to: set a state of the current call number as a vacant number when the current call is not deleted.

The call failure processing unit is further configured to: display interaction information used for inquiring whether to send a short message to the current call number when the call state shows that the current call number is unavailable and the current call number is not stored in a contact information set of the calling end.

Embodiments of the present application further provide a computer storage medium, storing computer executable instructions for executing the above method.

Compared with a relevant technology, the technical solution in embodiments of the present disclosure includes: initiating a call and detecting a call state of a call by a calling end; and displaying interaction information used for inquiring whether to send a short message to a current call number if a detected call state shows that a called end is busy. Through the technical solution in embodiments of the present disclosure, the user of the calling end can indicate to send a short message. At this moment, the calling end jumps to an interaction interface of the short message, wherein a receiver of the short message is configured as a current call number, and the user of the calling end only needs to input content of the short message to complete sending, thereby realizing convenient and quick contact with the user on a called end after call failure and improving user experience.

Other aspects will be appreciated upon reading and understanding the attached figures and detailed description.

### BRIEF DESCRIPTION OF DRAWINGS

FIG. 1 is a flow chart illustrating a method for reminding contact information in embodiments of the present disclosure;

FIG. 2 is a flow chart illustrating a method for reminding contact information in embodiments of the present disclosure; and

FIG. 3 is a schematic structural diagram illustrating a device for reminding contact information in embodiments of the present disclosure.

### DETAILED DESCRIPTION

Embodiments of the present disclosure will be described below in detail in combination with drawings. It should be noted that embodiments in the present application and features in embodiments can be combined mutually without conflict.

Steps shown in the flow charts of the drawings can be executed in, for example, a computer system of a set of computer executable instructions. Moreover, although a logic sequence is shown in the flow charts, in some cases, shown or described steps can be executed in a sequence different from the sequence herein.

It is well-known for those skilled in the art that in a communication terminal, such as a mobile phone, in the relevant technology, prompt and man-machine interaction with a user are performed generally in a mode of displaying interaction information. By taking pushed information generally displayed in the mobile phone, the pushed information, such as a news header, corresponds to detailed information such as news content. When the pushed information is selected, e.g., the pushed information is clicked, the detailed information corresponding to the pushed information is displayed. Apparently, the interaction information includes prompting information and other information such as information used for completing interaction. The prompting information is, for example, a header of a piece of news, or related Information of missed calls and the like, used for completing the interaction information such as optional dialog boxes and the like. By taking missed calls as an example, when the user clicks the dialog box, the mobile phone dials the call number of the missed call.

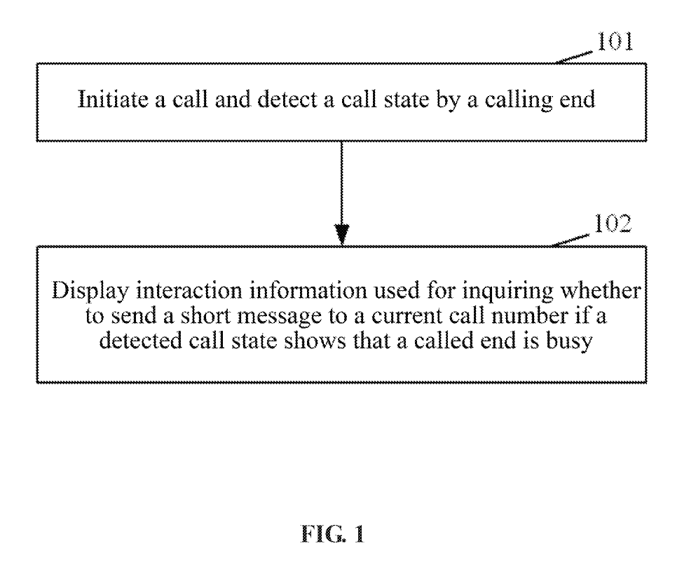

FIG. 1 is a flow chart illustrating a method for reminding contact information in embodiments of the present disclosure. As shown in FIG. 1, the method includes following steps.

In step 101, a calling end initiates a call and detects a call state of the call,

wherein expression information corresponding to prompting voice before the call is answered can be identified through a voice identification technology, and the call state is determined according to the identified expression information. Herein, how to identify the expression information of the prompting voice belongs to a commonly used technical means of those skilled in the art and is not used for limiting a protection scope of the present application, and is not repeated herein. Herein, how to determine the call state is illustrated.

For example, when the identified expression information is “the number you dialed is out of service”, the determined call state is out of service, and is used for showing that the called end is out of service. It is easy to see that how to determine the call state according to the identified expression information is easily realized by those skilled in the art, and is not repeated herein.

In step 102: the calling end displays interaction information used for inquiring whether to send a short message to a current call number if a detected call state shows that a called end is busy.

In this way, when the calling end receives an external instruction for indicating to send a short message, an interaction interface of the short message is displayed, wherein a receiver of the short message is configured as a current call number. After receiving content of the short message and the external instruction for indicating to send the short message, the calling end sends a short message to the called end, wherein the calling end can receive the external instruction and external information such as the content of the short message by performing man-machine interaction through a related man-machine interaction technology, e.g., according to displayed interaction information.

Optionally,

after detecting the call state in step 101, if the current call number is stored in a contact information set of the calling end, e.g., a phone book, the method further includes:

the calling end detects whether the calling end has an associated call number of the current call number if the call state shows that the called end is unavailable or out of service; and if an associated call number exists, interaction information used for inquiring whether to call a detected associated call number is displayed, wherein

associated call numbers are two or more call numbers of the same contact information, such as a contact person, stored in the contact information set such as the phone book. Herein, the phone book generally includes contact information of the contact person, such as the call numbers and social accounts.

In embodiments of the present disclosure, when the displayed associated call number is selected, the calling end dials the selected associated call number, thereby conveniently and quickly dialing other call numbers, i.e., associated call numbers, of the user of the called end when the called end is unavailable or out of service.

It is easy to understand that displaying interaction information used for inquiring whether to call a detected associated call number includes displaying associated call numbers. At this moment, optionally,

A method of displaying the associated call numbers includes: the associated call numbers are displayed according to a sequence of a recently contacted associated call number, an associated call number belonging to the same home location with the current call number, and other associated call numbers.

Specific realization of displaying the associated call numbers according to the above sequence belongs to a commonly used technical means of those skilled in the art and is not used for limiting a protection scope of the present application, and is not repeated herein.

Optionally,

the method in embodiments of the present disclosure further includes:

the calling end detects whether the calling end has an associated social account of the current call number if no associated call number exists; the detected associated social account is displayed if the associated social account exists; and, if the displayed associated social account is selected, an application program corresponding to the selected associated social account is started, wherein the associated social account of the call number is the social account belonging to the same contact information with the call number.

In this way, convenient and quick contact with a user of a called terminal through the associated social account is realized when the called end is unavailable or out of service and no associated call number of the current call number exists.

Optionally,

after detecting the call state in step 101, if the current call number is stored in a contact information set of the calling end, the method further includes:

interaction information used for inquiring whether to delete the current call number is displayed when the call state shows that the current call number is a vacant number.

In this way, when receiving the external instruction for deleting the current call number in a man-machine interaction mode, the calling end deletes the current call number from the contact information set, thereby conveniently and quickly deleting the call number which is the vacant number.

Optionally,

after the interaction information used for inquiring whether to delete the current call number is displayed, the method in embodiments of the present disclosure further includes: the state of the current call number is set as a vacant number when the current call is not deleted. In this way, the call numbers with the stage of the vacant number can be conveniently deleted in batch from the contact information set, and maintenance efficiency of the contact information set is increased.

Optionally,

after detecting the call state in step 101, if the current call number is not stored in a contact information set of the calling end, the method in embodiments of the present disclosure further includes:

interaction information used for inquiring whether to send a short message to a current call number is displayed if the call state shows that the current call number is unavailable.

In this way, convenient and quick contact with a user of a called terminal through the short message is realized when the called end is unavailable and the current call number is not stored in the contact information set of the calling end.

The method in the present application will be described in detail below in combination with specific embodiments.

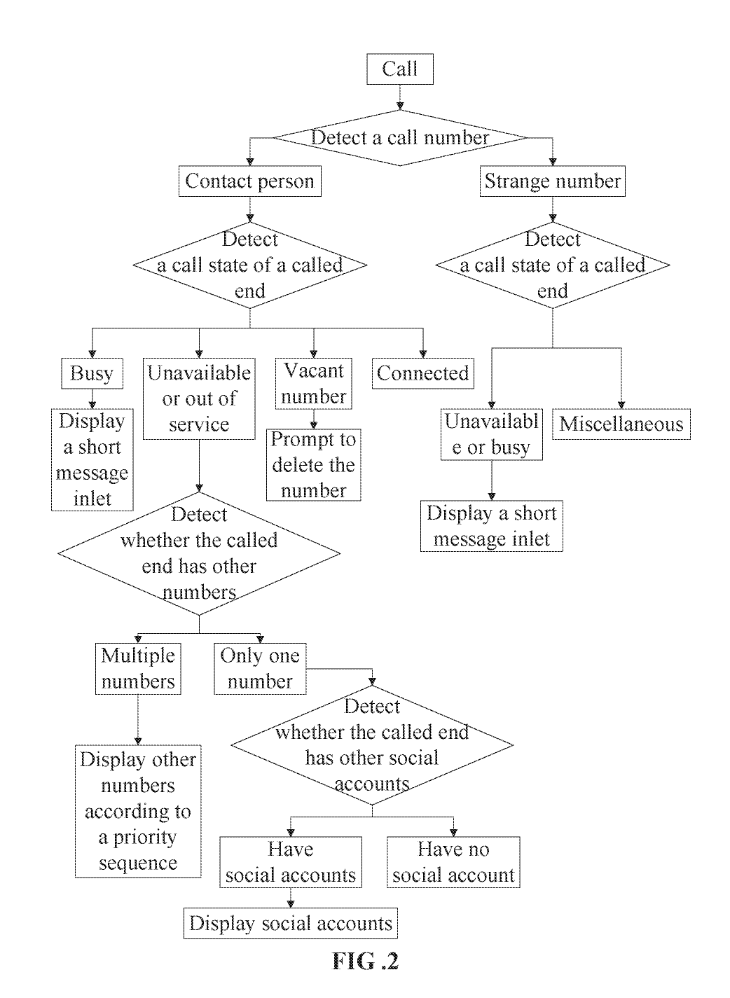

FIG. 2 is a flow chart illustrating a method for reminding contact information in embodiments of the present disclosure. As shown in FIG. 2, the method includes branches 201-204, 211 and 212.

When the called end is a contact person in the phone book:

in branch 201, if the called end is hung up or busy, it indicates that the user of the called end is busy or cannot answer the call. At this moment, a short message inlet, i.e., interaction information used for inquiring whether to send a short message to the current call number, is displayed on a call end interface, and the short message inlet is clicked to enter the short message interaction interface for sending the short message to the user of the called end. The short message can be sent to the user of the called end directly through the interaction interface.

In branch 202, if the called end is unavailable or out of service, at this moment, detailed information of the called end in the phone book is retrieved; other call numbers are displayed for the user to call if there are other call numbers, i.e., associated call numbers; other social accounts, i.e., associated social accounts, are displayed for the user to select if no other call number exists; and an application program corresponding to the selected associated social account is started if the displayed associated social account is selected.

In branch 203, if the user of the called end is a vacant number, the user is prompted as to whether to delete the call number at the end of the call. Then, if the current call number is not deleted, the phone book is marked, i.e., the state of the current call number is set as a vacant number in the phone book.

In other cases, e.g., in the branch 204, no relevant prompt is displayed on the call end interface.

For the branch 202, optionally,

if a plurality of other call numbers exist, other call numbers are displayed according to a priority sequence. Optionally, a recently contacted call number is preferably displayed; the home location of each call number is identified, and is compared with the home location of the number of the calling end; the call numbers on the same city are arranged behind the recently contacted number; and the rest call numbers are displayed after the recently contacted number and the call numbers on the same city.

How to identify the location of the call number belongs to a commonly used technical means of those skilled in the art and is not used for limiting a protection scope of the present application, and is not repeated herein.

When the called end is not a contact person in the phone book:

in branch 211, if the called end is unavailable or busy, a short message inlet is displayed on the call end interface.

In other cases, e.g., in the branch 212, no relevant prompt is displayed on the call end interface.

Embodiments of the present application further provide a computer storage medium, storing computer executable instructions for executing the above method.

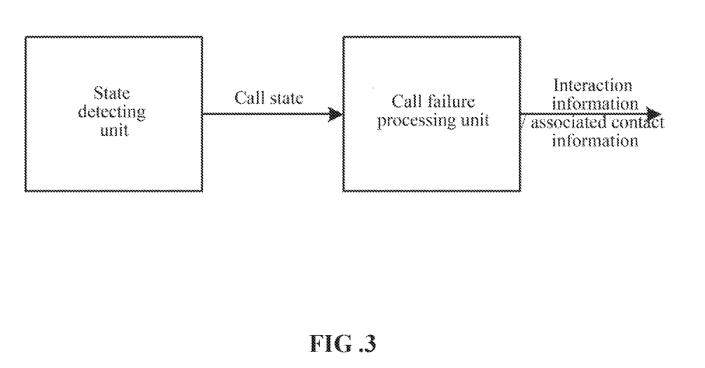

FIG. 3 is a schematic structural diagram illustrating a device for reminding contact information in embodiments of the present disclosure. The device is arranged in the communication terminal, such as the mobile phone. As shown in FIG. 3, the device includes a call state detecting unit and a call failure processing unit, wherein

the call state detecting unit is configured to detect a call state of a call; and

the call failure processing unit is configured to display interaction information used for inquiring whether to send a short message to a current call number if a detected call state shows that a called end is busy.

Optionally,

the call failure processing unit is further configured to: detect whether the calling end has an associated call number of the current call number when the call state shows that the called end is unavailable or out of service and the current call number is stored in a contact information set of the calling end; and if an associated call number exists, display interaction information used for inquiring whether to call a detected associated call number, wherein associated call numbers are two or more call numbers in the same contact information stored in the contact information set.

Optionally,

the call failure processing unit is configured to detect whether the calling end has an associated call number of the current call number when the call state shows that the called end is unavailable or out of service and the current call number is stored in a contact information set of the calling end; and display detected associated call numbers according to a sequence of a recently contacted associated call number, an associated call number belonging to the same home location with the current call number, and other associated call numbers if associated call numbers exist, and display other information in the interaction information.

Optionally,

the call failure processing unit is further configured to: detect whether the calling end has an associated social account of the current call number when detecting that the calling end has no associated call number; display the detected associated social account if the associated social account exists; and start an application program corresponding to the selected associated social account if the displayed associated social account is selected, wherein the associated social account of the call number is the social account belonging to the same contact information with the call number.

Optionally,

the call failure processing unit is further configured to: display interaction information used for inquiring whether to delete the current call number when the call state shows that the current call number is a vacant number and the current call number is stored in a contact information set of the calling end.

Optionally,

the call failure processing unit is further configured to: set the state of the current call number as a vacant number when the current call is not deleted.

Optionally,

when the call state shows that the current call number is unavailable and the current call number is not stored in the contact information set of the calling end, the call failure processing unit is further configured to: display interaction information used for inquiring whether to send a short message to the current call number.

Although embodiments disclosed in the present application are described above, contents described are only embodiments adopted for facilitating understanding of the present application, not intended to limit the present application.

Those ordinary skilled in the art can understand that all or some steps in above embodiments can be realized through computer program flows. Computer programs can be stored in a computer readable storage medium. The computer programs are executed on a corresponding hardware platform (such as a system, an equipment, a device, an apparatus and the like), and include one or a combination of steps of method embodiments when executed.

Optionally, all or some steps in above embodiments can also be realized through an integrated circuit. The steps can be respectively made into integrated circuit modules, or a plurality of modules or steps therein are made into a single integrated circuit module for realizing the steps.

Device/functional modules/functional units in above embodiments can be realized through a universal computing device, can be centralized on a single computing device, and can also be distributed on a network formed by a plurality of computing devices.

When realized in a form of software functional modules and sold or used as independent products, the device/functional modules/functional units in above embodiments can be stored in a computer readable storage medium. The above mentioned computer readable storage medium may be a read-only memory, a disk or an optical disc or the like.

### INDUSTRIAL APPLICABILITY

The above technical problem realizes convenient and quick contact with the user on the called end after call failure, thereby improving user experience.

1. A method for reminding contact information, comprising:
initiating, by a calling end, a call and detecting a call state; and
displaying, by the calling end, interaction information for inquiring whether to send a short message to a current call number when a detected call state indicates that a called end is busy,
wherein the method is performed by a computer system.

2. The method according to claim 1, further comprising:
detecting, after detecting the call state, whether the calling end is associated with a call number of the current call number when the current call number is stored in a contact information set of the calling end and the call state detected by the calling end indicates that the called end is unavailable or out of service; and
displaying, when the associated call number exists, interaction information for inquiring whether to call the detected associated call number.

3. The method according to claim 2, wherein:
displaying the interaction information for inquiring whether to call the detected associated call number comprises displaying the associated call number; and
displaying the associated call number comprises: displaying the associated call number according to a sequence of a recently contacted associated call number, an associated call number belonging to a same home location with the current call number, and other associated call numbers.

4. The method according to claim 2, further comprising:
detecting, by the calling end, whether the calling end is associated with a social account of the current call number when detecting that no associated call number exists;
displaying the detected associated social account when the associated social account exists; and
starting, when the displayed associated social account is selected, an application program corresponding to the selected associated social account.

5. The method according to claim 1, further comprising:
displaying, after detecting the call state, interaction information for inquiring whether to delete the current call number when the current call number is stored in a contact information set of the calling end and the call state detected by the calling end indicates that the current call number is a vacant number.

6. The method according to claim 5, further comprising:
setting, after displaying the interaction information for inquiring whether to delete the current call number, a state of the current call number as a vacant number when the current call number is not deleted.

7. The method according to claim 1, further comprising:
displaying, after detecting the call state, interaction information for inquiring whether to send a short message to the current call number when the current call number is not stored in a contact information set of the calling end and the call state detected by the calling end indicates that the current call number is unavailable.

8. A device for reminding contact information, comprising a computer system configured to:
initiate a call and detect a call state of the call; and
display interaction information for inquiring whether to send a short message to a current call number when a detected call state indicates that a called end is busy.

9. The device according to claim 8, wherein the computer system is further configured to: detect whether the calling end is associated with a call number of the current call number when the call state indicates that the called end is unavailable or out of service and the current call number is stored in a contact information set of the calling end; and display, when the associated call number exists, interaction information for inquiring whether to call a detected associated call number.

10. The device according to claim 9, wherein the computer system is further configured to: detect whether the calling end is associated with a call number of the current call number when the call state indicates that the called end is unavailable or out of service and the current call number is stored in a contact information set of the calling end; display, when the associated call number exists, the detected associated call number according to a sequence of a recently contacted associated call number, an associated call number belonging to a same home location with the current call number, and other associated call numbers; and display other information in the interaction information.

11. The device according to claim 9, wherein the computer system is further configured to:
detect whether the calling end is associated with a social account of the current call number when detecting that the calling end is not associated with a call number; display, when the associated social account exists, the detected associated social account; and start, when the displayed associated social account is selected, an application program corresponding to the selected associated social account.

12. The device according to claim 8, wherein the computer system is further configured to: display interaction information for inquiring whether to delete the current call number when the call state indicates that the current call number is a vacant number and the current call number is stored in a contact information set of the calling end.

13. The device according to claim 12, wherein the computer system is further configured to: set a state of the current call number as a vacant number when the current call number is not deleted.

14. The device according to claim 8, wherein the computer system is further configured to: display interaction information for inquiring whether to send a short message to the current call number when the call state indicates that the current call number is unavailable and the current call number is not stored in a contact information set of the calling end.

15. A non-transitory computer storage medium, storing computer executable instructions that when executed by a computer system cause the computer system to perform a method comprising:
initiating a call and detecting a call state; and
displaying interaction information for inquiring whether to send a short message to a current call number when a detected call state indicates that a called end is busy.

16. The method according to claim 3, further comprising:
detecting, by the calling end, whether the calling end is associated with a social account of the current call number when detecting that no associated call number exists;
displaying the detected associated social account when the associated social account exists; and
starting, when the displayed associated social account is selected, an application program corresponding to the selected associated social account.

17. The method according to claim 2, further comprising:
displaying, after detecting the call state, interaction information for inquiring whether to send a short message to the current call number when the current call number is not stored in a contact information set of the calling end, and the call state detected by the calling end indicates that the current call number is unavailable.

18. The method according to claim 5, further comprising:
displaying, after detecting the call state, interaction information for inquiring whether to send a short message to the current call number when the current call number is not stored in a contact information set of the calling end, and the call state detected by the calling end indicates that the current call number is unavailable.

19. The device according to claim 10, wherein the computer system is further configured to:
detect whether the calling end is associated with a social account of the current call number when detecting that the calling end is not associated with a call number; display, when the associated social account exists, the detected associated social account; and start, when the displayed associated social account is selected, an application program corresponding to the selected associated social account.

20. The device according to claim 9, wherein the computer system is further configured to: display interaction information for inquiring whether to send a short message to the current call number when the call state indicates that the current call number is unavailable and the current call number is not stored in a contact information set of the calling end.
